(19) United States
(12) Patent Application Publication
(10) Pub. No.: US 2025/0223404 A1
(43) Pub. Date: Jul. 10, 2025

(54) SHAPED ARTICLE COMPRISING A POLY(ARYL ETHER SULFONE) (PAES) POLYMER AND METHOD OF MAKING USING MELT PROCESSING

(71) Applicant: Solvay Specialty Polymers USA, LLC, Alpharetta, GA (US)

(72) Inventor: Kamlesh P. NAIR, Alpharetta, GA (US)

(21) Appl. No.: 18/727,708

(22) PCT Filed: Jan. 18, 2023
(86) PCT No.: PCT/EP2023/051149

§ 371 Date: Jul. 10, 2024

Related U.S. Application Data
(60) Provisional application No. 63/300,667, filed on Jan. 19, 2022.

(30) Foreign Application Priority Data
Mar. 18, 2022 (EP) 22162978.5

(51) Int. Cl. C08G 75/23

(52) U.S. Cl. CPC C08G 75/23; C08G 2150/20

(57) ABSTRACT

The present invention relates to a shaped article comprising at least one poly(aryl ether sulfone) (PAES) polymer made from at least one naphthalene diol monomer and at least one dihalodiphenyl sulfone monomer; a method of making such article and its use in biomedical, food, beverage applications, automotive, aerospace, electrical, electronic, industrial product applications and/or in composites.

### CROSS-REFERENCE TO RELATED APPLICATIONS

This application claims priority to U.S. provisional patent application No. 63/300,667 filed on Jan. 19, 2022 and European patent application No. 22162978.5 filed on Mar. 18, 2022, the whole content of these applications being incorporated herein by reference for all purposes.

### TECHNICAL FIELD

The present invention relates to a shaped article comprising at least one poly(aryl ether sulfone) (PAES) polymer derived from at least one naphthalene diol monomer. The present invention also relates to the method for making this shaped article using melt processing and its use in medical applications, in food and beverage applications, in aerospace applications and/or and in composites amongst various applications.

### BACKGROUND ART

Poly(aryl ether sulfone) polymers (PAES) is a generic term used to describe any polymer containing at least one sulfone group (—SO2-), at least one ether group (—O—) and at least one arylene group. PAES have been utilized for making products in different fields of applications, for instance in the medical market, due to their excellent mechanical and thermal properties, coupled with outstanding hydrolytic stability.

PAES are made by polycondensation reactions typically using a dihalodiphenyl sulfone (the sulfone monomer) along with at least one aromatic diol monomer such as Bisphenol A (BPA), biphenol (BP) or dihydroxydiphenyl sulfone (DHDPS) also known as Bisphenol S (BPS).

A commercially important group of PAES includes polysulfone polymers identified herein as polysulfones, in short PSU. PSU polymers contain recurring units derived from the condensation of BPA and a dihalogen sulfone monomer, for example 4,4′-dichlorodiphenyl sulfone (DCDPS). Such PSU polymers are commercially available from Solvay Specialty Polymers USA LLC under the trademark UDEL®. The structure of the repeating units of such a PSU polymer is shown below:

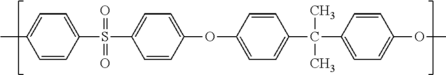

PSU polymers have a high glass transition temperature (e.g., about 185° C.) and exhibit high strength and toughness.

Another important group of PAES includes polyethersulfone polymers, in short PES. PES polymers derive from the condensation of BPS and a dihalogen sulfone monomer, for example DCDPS. Such PES polymers are commercially available from Solvay Specialty Polymers USA LLC under the trademark VERADEL®. The structure of the repeating units of such a PES polymer is shown below:

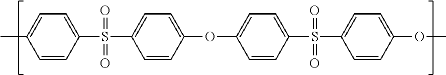

Another important group of PAES includes poly(biphenyl ether sulfone) polymers, in short PPSU. PPSU is made by reacting 4,4′-biphenol (BP) and a dihalogen sulfone monomer, for example DCDPS, and it is notably commercially available from Solvay Specialty Polymers USA LLC under the tradename Radel®. The structure of the repeating units of such PPSU polymer is shown below:

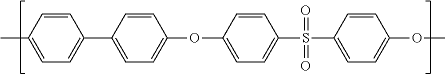

It is generally accepted in the art that the mechanical properties of the PPSU depend upon its molecular weight and that the higher the molecular weight, the higher the mechanical properties. The consequence of a PPSU of high molecular weight is however that it exhibits high melt viscosity, which then makes PPSU less attractive for certain markets. For injection molding of thin wall parts for example, it is still desirable to have a PPSU that has low melt viscosities, so that molding operations can be performed with improved flow and molding performance. Because of its high viscosity, PPSU is usually processed at a temperature between 36° and 400° C. which is far beyond its Tg of 220° C.

PAES are highly thermally stable polymers with excellent toughness and impact strength. PAES are used in diverse applications such as in composites, in injection molded articles and in membrane applications.

For applications including those requiring contact with water, food, beverage, drugs and/or blood, it is important that polymeric materials are safe both for humans and environment. Polymeric materials in contact with food and drugs must meet certain requirements mandated by for instance the U.S. Food and Drug Administration (FDA), the European Food Safety Agency and the Environmental Protection Agency (EPA).

However diol monomers such as BPA and BPS are chemicals of concern for potential endocrine disruption in medical or food contact applications. PSU and PES polymers, respectively based on BPA and BPS, are frequently used to make articles, including plastic bottles and food and beverage cans since the 1960s and further to prepare membranes to be used in contact with biological fluids, for example blood. In recent years, concerns have been raised about BPA and BPS's safety.

To overcome this concern, several publications disclose the use of alternative diols such as isosorbide and tetramethyl bisphenol F (TMBPF) to make PAES since these diols seem to have less potential endocrine disruption, for example in WO 2019/048652A1 and WO 2021/110954A1, both by SOLVAY SPECIALTY POLYMERS USA.

However these diol monomers are based on either cycloaliphatic units in the case for isosorbide and/or have benzylic protons as in the case of tetramethyl bisphenol F (TMBPF), both these groups are thermally sensitive materials as a result of which the end use application and polymer processing becomes limited to only solution processing at low temperature.

US 2014/0113093A1 (SOLVAY SPECIALTY POLYMERS USA) also describes PAES polymers derived from specific aromatic diols, which have weak binding affinity for estrogen receptors and are well-suited for the food and drugs industry, advantageously having a lower risk for human health.

The invention further relates to compositions containing such polymers, and articles made from such polymers.

None of these documents describes the use of naphthalene diol to make PAES polymers and then articles made therefrom.

Generally, the type and quality of articles that can be formed from a polymer depends on the processability of the polymer. Melt processing a polymer involves heating the polymer at high temperature; generally well above the glass transition temperature to form a molten polymer prior to fabrication of the article. The thermo-chemical stability of the polymer at such elevated temperatures is a significant factor in determining the suitability of this polymer for an intended shaped (e.g., molded) article. Accordingly, amorphous PAES polymers having increased melt-processability could be used in a large number of application settings using melt-processing techniques, compared to PAES polymers having lower melt-processability which either degrade or crosslink at elevated temperatures used in the melt processing.

An amorphous polymeric material such as a PAES having improved thermal performance combined with having very good mechanical properties provides opportunities in high-temperature injection molding applications that traditionally have been limited to filled, semi-crystalline polymers. For example, applications for such PAES polymers include opportunities in metal replacement as well as high-performance thermoset resins in a wide range of engineering applications. This included automotive, aerospace, electrical, electronic, and industrial product applications, manufacture of or use in composites.

There is also a continuous need for shaped articles made from polymeric materials especially polyethersulfones obtained from diol monomers (M) which have weak binding affinity for estrogen receptors and whereby said polymeric materials are particularly thermally resistant melt-processable while exhibiting good mechanical properties. The use of such amorphous PAES material having low estrogenic activity compared to PAES made from BPA and BPS provides opportunities in making articles intended to be in contact with food, beverage, drugs, biological fluids such as blood and/or water, for example use to make components of biomedical devices, such as tubing used in medical applications, use to make articles intended to be in contact with food such as baby bottles.

### SUMMARY OF INVENTION

The Applicant has now found that certain PAES polymeric materials based on naphthalene diol monomer can solve above mentioned problems.

The present invention is set out in the appended set of claims

In particular, a first aspect of the present disclosure is directed to a shaped article, as defined in any one of claims 1-13. The shaped article comprises a PAES polymer containing at least 80 mol. %, based on the total number of moles of recurring units in the PAES polymer, of recurring units (R_{PAES}) of formula (I):

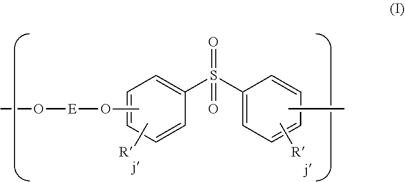

wherein:
E is selected from formula (IIa)

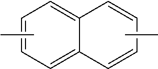

and/or formula (IIb)

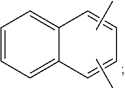

each R is, independently at each location, an alkyl having from 1 to 5 carbon atoms; and
j′ is 0 or an integer from 1 to 10, preferably j′=0.

In some embodiments, the PAES in the shaped article is obtained from the condensation of at least one naphthalene diol monomer and a dihalodiphenyl sulfone.

Non-limitative examples of shaped articles according to the invention are notably food and/or beverage containers such as baby bottles, tubing such as biomedical tubing, pipes, fittings, housings, coatings, and/or composites.

A second aspect of the present invention is a method for preparing the shaped article as defined in any one of claims 14 to 16. The method comprises using the PAES polymer described herein. In some embodiments, the method for preparing the shaped article according to the present invention may comprise melt processing a composition comprising the naphthalene diol-based PAES described herein to form the article.

A third aspect of the present disclosure is directed to the use of the shaped article, as defined in claim 17, suitable for biomedical applications such as biomedical tubing, coatings and/or tough thermoplastic composites.

More precisions and details about these subject matters are now provided below.

### DETAILED DESCRIPTION OF THE PREFERRED EMBODIMENTS

In the present application:
any description, even though described in relation to a specific embodiment, is applicable to and interchangeable with other embodiments of the present disclosure;
where an element or component is said to be included in and/or selected from a list of recited elements or components, it should be understood that in related embodiments explicitly contemplated here, the element or component can also be any one of the individual recited elements or components, or can also be selected from a group consisting of any two or more of the explicitly listed elements or components; any element or component recited in a list of elements or components may be omitted from such list; and
any recitation herein of numerical ranges by endpoints includes all numbers subsumed within the recited ranges as well as the endpoints of the range and equivalents.

As used herein and unless explicitly stated otherwise, “substantially free of” a component in a substance (such as reaction mixture, monomers mixture, a polymer, a shaped article . . . ) means that the concentration of the component is no more than 1 wt. % or no more than 0.5 wt. % based on the total weight of such substance. Furthermore this particular component may be in free state or in a bound state in the substance.

As used herein and unless explicitly stated otherwise, “free of” a component in a substance (such as reaction mixture, monomers mixture, a polymer, a shaped article . . . ) means that the concentration of the component is no more than 0.1 wt. % or no more than 0.05 wt. %, based on the total weight of such substance. Furthermore this particular component may be in free state and/or in a bound state to the substance.

When “substantially free of” or “free of” are used in the context of a ‘binding’ compound (e.g., BPA monomer) of a polymer or article which is “substantially free” or “free” of bound compound (BPA), the term “bound” is meant to be understood that the polymer or article contains less than the aforementioned amount of recurring units derived from such binding compound (BPA). For example a polymer substantially free of bound BPA when present contains no more than 1 wt. % of BPA-derived recurring units.

For the purpose of the present invention, the expression “substantially all” in combination with a recited amount of recurring units in a polymer is hereby intended to mean that minor amounts, generally below 1 mol %, preferably below 0.5 mol %, of other recurring units may be tolerated, e.g., as a result of lower purity in monomers used.

The expression “polymer” is hereby used to designate a homopolymer containing substantially all of the same recurring units and a copolymer comprising at least 50 mol. % of the same recurring units, for example at least about 60 mol. %, at least about 65 mol. %, at least about 70 mol. %, at least about 75 mol. %, at least about 80 mol. %, at least about 85 mol. %, at least about 90 mol. %, at least about 95 mol. % or at least about 98 mol. %.

The term “estrogen activity” or “estrogen agonist activity” refers to the ability of a substance to mimic hormone-like activity through interaction with the endogenous estrogen receptor, typically the endogenous human estrogen receptor.

The Applicant has found that certain PAES polymeric materials based on naphthalene diol monomer have at least one of the following properties:
a high elastic modulus at high temperature (such as E₁₉₀≥400 MPa, preferably 600 MPa, more preferably ≥800 MPa measured at 190° C. via ASTM D5279); and/or
a suitable melt stability represented by VR40, wherein VR40 is ratio of the melt viscosity at 40 minutes (“MV40”) to melt viscosity at 5 minutes (“MV5”), said melt viscosities being measured using ASTM D3835: VR40=MV40/MV5 (such as VR40 measured at 380° C. from 0.95 to 1.05 or a VR40 measured at 410° C. s 2, preferably ≤1.9); and/or
a glass transition temperature Tg of from 200° C. to 250° C. or from 205° C. to 240° C., wherein the Tg is measured via Differential Scanning Calorimeter (DSC).

The Applicant has further found that certain PAES polymeric materials based on naphthalene diol monomer (particularly 2,7-NDO monomer) are characterised with a low thermal loss in elastic modulus (% loss) of at most 15%, preferably of at most 13%, more preferably of at most 11%, wherein % loss=(E₅₀−E₁₉₀)/E₅₀, said E₅₀ being the elastic modulus of the polymeric material measured at 50° C., and E₁₉₀ being the elastic modulus of the polymeric material, both measured using ASTM D5279.

The introduction of these naphthalene moieties do not compromise the thermal processing and thermo-mechanical performance of the final polymers that would be amenable for high-temperature polymer recovery such as in melt extrusion or molding.

These naphthalene groups do not compromise the solubility of the resultant polymers as a result of which, the polymers are both solution processable as well as melt processable. This widely increases the scope of application and processability as compared to PAES polymers based on alternative diols such as isosorbide or tetramethyl bisphenol F (TMBPF).

The presence of these naphthalene rings can provide additional performance benefits as well such as increased thermo-mechanical properties and increase stiffness at higher temperatures as compared to for example 4,4′-biphenol since the naphthalene rings being fused to each other do not lower the stiffness at higher temperatures. Such performance attributes could be advantageous in applications such as composites, injection molded articles, coating etc.

The applicant has found that the present invention allows to obtain a shaped article from, at least in part, a PAES polymer having a good viscosity stability and high elastic modulus at high temperature (such as 190° C.), notably being melt processable, and most useful for molding, particularly injection molding. The thermo-mechanical performance of the PAES polymer is similar to that of commercially available PES polymers. These PAES polymers can then be used to prepare shaped articles via melt processing to be used in food, beverage, medical, automotive, aerospace, electrical, electronic, and industrial product applications and/or in composites.

The applicant has further found that certain naphthalene diol monomers which have low estrogenic activity (compared to the commonly used diols: BPA, BPS and/or BP) can be used to successfully prepare PAES polymers with the right set of thermal and mechanical properties to prepare shaped articles. Since the PAES polymers incorporating such monomers are expected to also exhibit reduced estrogenic activity, the shaped articles containing them would pose lower risks for human health compared to shaped articles comprising PAES derived from BPA, BPS and/or BP, and therefore should be suitable for use in food, beverage and/or biomedical applications where polymeric surfaces would be in contact with for example food, beverage, biological fluids and/or drugs.

### The Shaped Article

The shaped article is preferably selected from the group consisting of a tubing, a pipe, a food or beverage container such as baby bottle, a fitting, a housing, a coating, a composite or component thereof, and any combination thereof.

In some embodiments, the shaped article comprises a PAES polymer containing at least 80 mol. %, based on the total number of moles of recurring units in the PAES polymer, of recurring units (R_{PAES}) of the formula (I), wherein:
E is selected from formula (IIa)

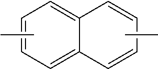

and/or formula (IIb)

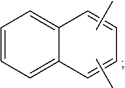

each R₁ is, independently at each location, an alkyl having from 1 to 5 carbon atoms, and
j is 0 or an integer from 1 to 10.

E in the recurring units (R_{PAES}) of the formula (I) may be selected from the group consisting of;

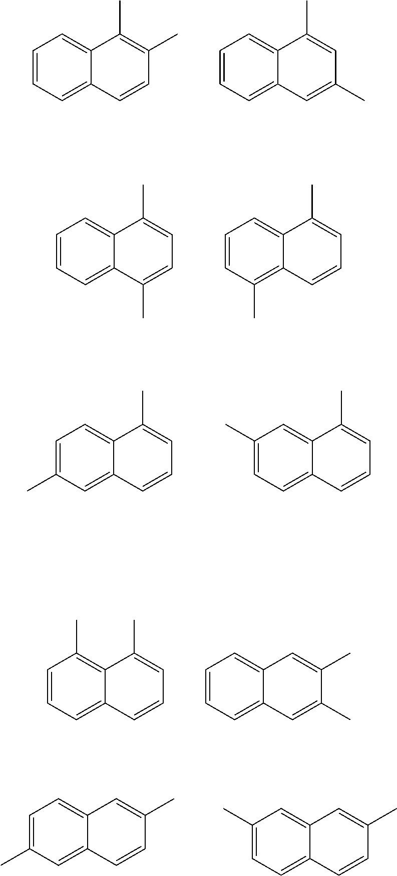

and any combination thereof.

E in the recurring units (R_{PAES}) of the formula (I) is preferably selected from the group consisting of:

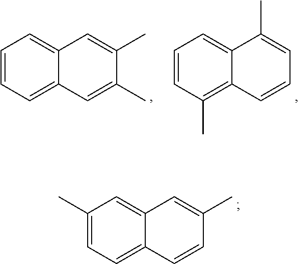

and any combination thereof.

E in the recurring units (R_{PAES}) of the formula (I) may exclude the following structure:

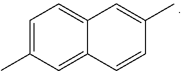

j′ in the formula (I) is preferably 0.

The PAES polymer in the shaped article can be a homopolymer or a copolymer. If it is a copolymer, it can be a random, alternate or block copolymer.

The PAES polymer in the shaped article comprises at least 90 mol. %, at least 95 mol. %, or at least 99 mol. %, based on the total number of moles of recurring units in the PAES polymer, of the recurring units (R_{PAES}) of formula (I). Preferably, the PAES polymer in the shaped article comprises substantially all recurring units (R_{PAES}) of formula (I).

In preferred embodiments, the shaped article comprises a PAES polymer containing at least 80 mol. %, based on the total number of moles of recurring units in the PAES polymer, of recurring units (R_{PAES}) selected from the group consisting of formulae (I-a), (I-b), (I-c) and any combinations thereof:

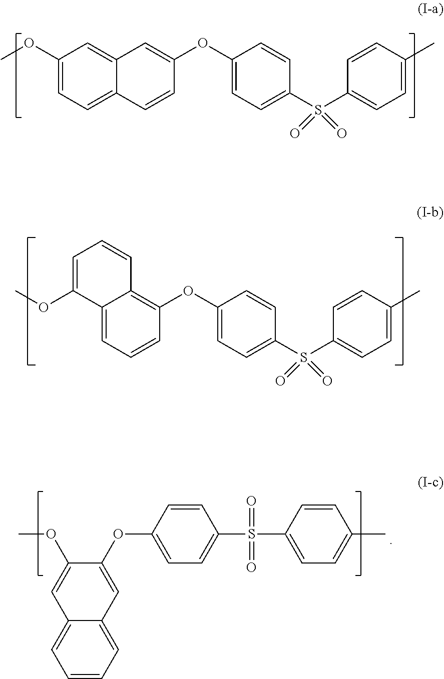

In more preferred embodiments, the shaped article comprises a PAES polymer containing at least about 85 mol. %, at least about 90 mol. %, at least about 95 mol. % or at least about 98 mol. %, based on the total number of moles of recurring units in the PAES polymer, of recurring units (R_{PAES}) of formula selected from formulae (I-a), (I-b) and/or (II-c), preferably selected from formulae (I-a) and/or (I-b), more preferably of formula (I-a).

In even more preferred embodiments, the shaped article comprises a PAES polymer containing substantially all of the same recurring units (R_{PAES}) of formula selected from formulae (I-a), (I-b) and/or (II-c), preferably of formula (I-a) and/or (I-b), more preferably of formula (I-a).

The PAES polymer in the shaped article may be substantially free of 4,4′-dihydroxydiphenyl sulfone (BPS), 4,4′-isopropylidenediphenol (BPA) and/or 4,4′-biphenol (BP), preferably substantially free of BPA and BPS or free of BPA and BP, more preferably substantially free of all three. The BPA, BPS and/or BP may be in free or bound state in the PAES polymer.

In some embodiments, the PAES polymer in the shaped article preferably excludes sulfone recurring units derived from BPA, BPS and BP.

In some embodiments, the shaped article is preferably substantially free of BPA, BPS and/or BP whether they be in free or bound state, preferably substantially free of BPA and BPS whether they be in free or bound state or substantially free of BPA and BP whether they be in free or bound state, more preferably substantially free of all three.

In some embodiments, the shaped article comprising the PAES obtained from some specific naphthalene diol monomers is expected to have a low endocrine disruption potential and should exhibit lower estrogenic activity compared to a shaped article comprising a PAES obtained from BPA, BPS and/or BP.

More precisely, the shaped article comprises the PAES obtained from a naphthalene diol monomer which has an EC₅₀ response value to the estrogen receptor alpha (ERα) of at least 30000 nM.

In preferred embodiments, the shaped article comprises the PAES obtained from a naphthalene diol monomer selected from the group consisting of 1,5-naphthalene diol isomer, 2,3-naphthalene diol isomer and 2,7-naphthalene diol isomer, more preferably selected from the group consisting of 1,5-naphthalene diol isomer and 2,7-naphthalene diol isomer.

The shaped article may comprise the PAES described herein in an amount of at least 1 wt. %, for example at least 5 wt. %, at least 10 wt. %, at least 15 wt. %, at least 20 wt. %, at least 25 wt. %, or at least 30 wt. %, based on the total weight of the shaped article.

The shaped article may comprise the PAES described herein in an amount of more than 50 wt. %, for example more than 55 wt. %, more than 60 wt. %, more than 65 wt. %, more than 70 wt. %, more than 75 wt. %, more than 80 wt. %, more than 85 wt. %, more than 90 wt. %, more than 95 wt. % or more than 99 wt. %, based on the total weight of the shaped article.

The shaped article may further comprise at least one polymer distinct form the PAES described herein, for example another sulfone polymer, e.g., polysulfone (PSU), polyarylethersulfone (PPSU), polyethersulfone (PES), or a polyphenylene sulfide (PPS), a poly(aryl ether ketone) (PAEK), e.g. a poly(ether ether ketone) (PEEK), a poly(ether ketone ketone) (PEKK), a poly(ether ketone) (PEK) or a copolymer of PEEK and poly(diphenyl ether ketone) (PEEK-PEDEK copolymer), polyetherimide (PEI), and/or polycarbonate (PC). The other polymeric ingredient can also be polyvinylpyrrolidone and/or polyethylene glycol. In such instances, the shaped article of the present invention may comprise at least one polymer distinct form the PAES described herein in an amount of at most 50 wt. %, for example at most 45 wt. %, at most 40 wt. %, at most 35 wt. %, at most 30 wt. %, at most 25 wt. %, at most 20 wt. %, at most 15 wt. %, at most 10 wt. %, at most 5 wt. %, at most 2 wt. %, or at most 1 wt. %, based on the total weight of the shaped article.

The shaped article may also further comprise at least one additional ingredient such as a solvent, a filler, a lubricant, a light stabilizer, a UV stabilizer, a heat stabilizer, a plasticizer, an impact modifier/toughener, a nucleating agent, an antioxidant, a mold release, an antistatic agent, a flame retardant, an anti-fogging agent, a matting agent, a pigment, a dye and/or an optical brightener.

In such instances, the shaped article may comprise more than 0 wt % and up to 20 wt % (based on the total weight of the polymer composition) of one or more optional additional ingredients excluding fillers.

In some embodiments, the shaped article may comprise more than 5 wt % and up to 70 wt % (based on the total weight of the polymer composition) of one or more optional fillers.

### Method for Making the PAES

The PAES in the shaped article is preferably obtained by the condensation in a reaction mixture (R_{G}) of:
at least one aromatic dihydroxy monomer (a), comprising at least 80 mol. %, based on the total number of moles of monomer (a), of a naphthalene diol monomer (a1) of formula (IIIa) and/or (IIIb):

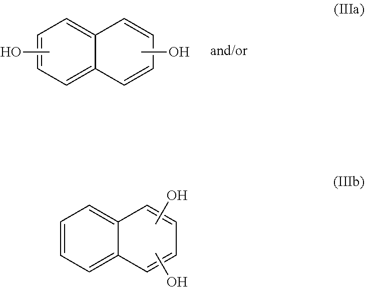

at least one aromatic dihalogen sulfone monomer (b), comprising at least 50 mol %, based on the total number of moles of monomer (b), a monomer (b1) of formula (IV):

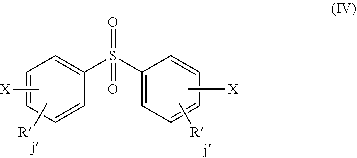

at least one carbonate component,
in a solvent,

wherein:
each R′ is, independently at each location, an alkyl having from 1 to 5 carbon atoms;
j′ is an integer from 0 to 10, preferably j′=0; and
X is an halogen atom, preferably F or Cl, more preferably Cl.

The at least one aromatic dihydroxy monomer (a) comprises at least about 85 mol. %, at least about 90 mol. %, at least about 95 mol. % or at least about 98 mol. %, based on the total number of moles of monomer (a), of the monomer (a1). According to a preferred embodiment, the aromatic dihydroxy monomer (a) consists essentially of the monomer (a1).

In preferred embodiments, the naphthalene diol monomer (a1) is preferably a naphthalene diol isomer which has an estrogen agonist activity lower than Bisphenol A (BPA). In some embodiments, the naphthalene diol monomer (a1) is preferably a naphthalene diol isomer which has an estrogen agonist activity lower than Bisphenol S (BPS). In some embodiments, the naphthalene diol monomer (a1) is preferably a naphthalene diol isomer which has an estrogen agonist activity lower than 4,4′-biphenol (BP).

The naphthalene diol monomer (a1) preferably has an EC₅₀ response value to the estrogen receptor alpha (ERα) of at least 30000 nM.

The monomer (a1) preferably comprises a naphthalene diol isomer selected from the group consisting of isomers of formulae (5a) to (5j):

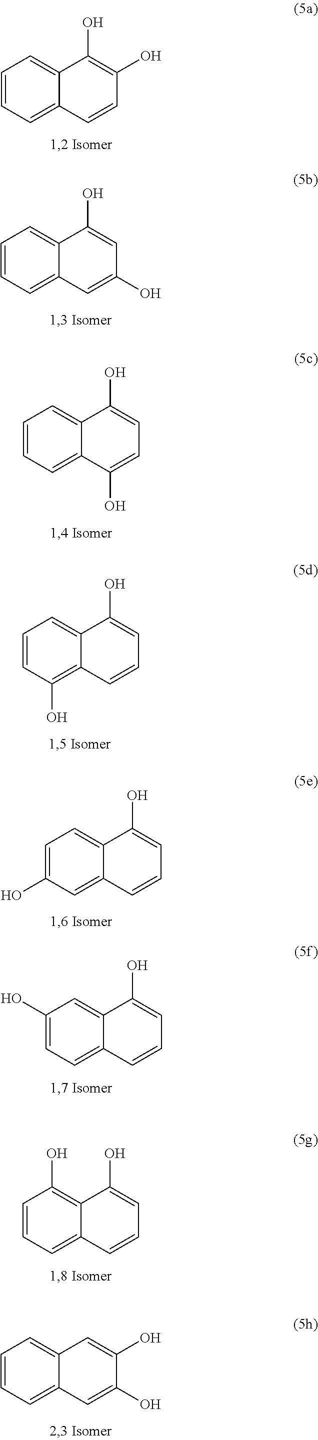

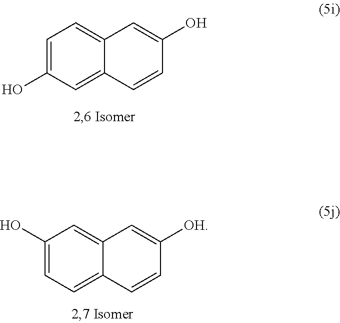 [SMILES: Oc1ccc2cc(O)ccc2c1 ; Oc1ccc2ccc(O)cc2c1]

The monomer (a1) may for example comprise, based on the total weight of the monomer (a), at least 80 wt. %, at least 90 wt. %, at least 95 wt. %, or at least 99 wt. %, of the naphthalene diol isomer selected from the group consisting of isomers of formulae (5a) to (5j).

The naphthalene diol monomer (a1) is more preferably selected from the group consisting of 1,5-naphthalene diol isomer of formula (5d), 2,3-naphthalene diol isomer of formula (5h) and 2,7-naphthalene diol isomer of formula (5d), yet more preferably selected from the group consisting of 1,5-naphthalene diol isomer and 2,7-naphthalene diol isomer.

In some embodiments, the naphthalene diol monomer (a1) excludes the 2,6-naphthalene diol isomer of formula (5i).

The at least one aromatic dihalogen sulfone monomer (b) comprises at least about 60 mol. %, at least about 65 mol. %, at least about 70 mol. %, at least about 75 mol. %, at least about 80 mol. %, at least about 85 mol. %, at least about 90 mol. %, at least about 95 mol. %, or at least about 98 mol. %, based on the total number of moles of monomer (b), of the monomer (b1). According to a preferred embodiment, the aromatic dihalogen sulfone monomer (b) consists essentially of monomer (b1).

The monomer (b) preferably comprises at least 50 mol. % of 4,4′-dichlorodiphenyl sulfone (DCPDS) and/or 4,4′-difluorodiphenyl sulfone (DFPDS) as monomer (b1), based on the total moles of aromatic dihalogen sulfone monomer (b). The monomer (b) more preferably comprises at least about 60 mol. %, at least about 65 mol. %, at least about 70 mol. %, at least about 75 mol. %, at least about 80 mol. %, at least about 85 mol. %, at least about 90 mol. %, at least about 95 mol. % or at least about 98 mol. %, based on the total number of moles of monomer (b), of DCPDS and/or DFDPS as monomer (b1).

In particular embodiments, the reaction mixture (R_{G}) is substantially free of BPA, BPS, and/or BP, preferably substantially free of BPA and BPS, more preferably substantially free of all three.

The molar ratio of monomers (a) to (b) may vary between 0.9 and 1.1. For example the molar ratio of (a) to (b) may vary from 1.01 to 1.05.

The solvent used to prepare the PAES described herein may be selected from a group consisting of dimethylsulfoxide (DMSO), dimethylsulfone (DMS), diphenylsulfone (DPS), 1,3-dimethyl-2-imidazolidinone (DMI), diethylsulfoxide, diethylsulfone, diisopropylsulfone, tetrahydrothiophene-1, 1-dioxide, tetrahydrothiophene-1-monoxide, N-methylpyrrolidone (NMP), N-butylpyrrolidone (NBP), N-ethyl-2-pyrrolidone, N,N-dimethylformamide (DMF), N,N dimethylacetamide (DMAC), tetrahydrofuran (THF), toluene, benzene, monochlorobenzene, dichlorobenzene, anisole, chloroform, dichloromethane (DCM), sulfolane, and mixtures thereof.

The condensation described herein may be carried out in the presence of a carbonate component which is selected in the group of alkali metal hydrogencarbonates, for example sodium hydrogencarbonate (NaHCO₃) and potassium hydrogencarbonate (KHCO₃), or in the group of alkali metal carbonate, for example potassium carbonate (K₂CO₃) and sodium carbonate (Na₂CO₃). Preferably the condensation is carried out in the presence of potassium carbonate (K₂CO₃), sodium carbonate (Na₂CO₃) or a blend of both. According to an embodiment, t the condensation is carried out in the presence of a low particle size alkali metal carbonate, for example comprising anhydrous K₂CO₃, having a volume-averaged particle size of less than about 100 μm, for example less than 45 μm, less than 30 μm or less than 20 μm. According to a preferred embodiment, the condensation is carried out in in the presence of a carbonate component comprising not less than 50 wt. % of K₂CO₃ having a volume-averaged particle size of less than about 100 μm, for example less than 45 μm, less than 30 μm or less than 20 μm, based on the overall weight of the base component in reaction mixture. The volume-averaged particle size of the carbonate used can for example be determined with a Mastersizer 2000 from Malvern on a suspension of the particles in chlorobenzene/sulfolane (60/40 v/v).

The molar ratio of carbonate component:dihydroxy monomer (a) may be from 1.0 to 1.2, for example from 1.01 to 1.15 or from 1.02 to 1.1. The molar ratio of carbonate component:dihydroxy monomer (a) is preferably 1.05 or higher, for example 1.06 or 1.08.

According to the condensation reaction, the components of the reaction mixture (R_{G}) are generally reacted concurrently. The condensation is preferably conducted in one stage. This means that the deprotonation of monomer (a) and the condensation reaction between the monomers (a) and (b) takes place in a single reaction stage without isolation of the intermediate products.

According to an embodiment for PAES polymer manufacture, the condensation is carried out in a mixture of a polar aprotic solvent and a solvent which forms an azeotrope with water. The solvent which forms an azeotrope with water includes aromatic hydrocarbons such as benzene, toluene, xylene, ethylbenzene, monochlorobenzene and the like. It is preferably toluene or monochlorobenzene. The azeotrope forming solvent and polar aprotic solvent are used typically in a weight ratio of from about 1:20 to about 1:1 or from about 1:10 to about 1:1, preferably from about 1:5 to about 1:1. Water is continuously removed from the reaction mass as an azeotrope with the azeotrope forming solvent so that substantially anhydrous conditions are maintained during the polymerization. The azeotrope-forming solvent, for example, monochlorobenzene, is removed from the reaction mixture, typically by distillation, after the water formed in the reaction is removed leaving the PAES dissolved in the polar aprotic solvent.

Preferably, the reaction mixture (R_{G}) does not comprise any substance which forms an azeotrope with water.

In some embodiments, the process is such that the conversion (C) is at least 95%.

The temperature of the condensation reaction mixture is kept at about 150° C. to about 350° C., preferably from about 210° C. to about 300° C. for about one to 15 hours.

The reaction mixture is polycondensed, within the temperature range, until the requisite degree of condensation is reached. The polycondensation time can be from 0.1 to 10 hours, preferably from 0.2 to 6 hours, from 0.2 to 4 hours, or from 0.5 to 2 hours, depending on the nature of the starting monomers and on the selected reaction conditions.

The inorganic constituents, for example sodium chloride or potassium chloride or excess of base, can be removed, before or after isolation of the PAES, by suitable methods such as dissolving and filtering, screening or extracting.

According to an embodiment, the amount of PAES at the end of the condensation is at least 30 wt. % based on the total weight of the PAES and the polar aprotic solvent, for example at least 35 wt. % or at least or at least 37 wt. % or at least 40 wt. %.

At the end of the reaction, the PAES polymer is separated from the other components (salts, base, . . . ) to obtain a PAES solution. Filtration can for example be used to separate the PAES polymer from the other components. The PAES can be recovered from the solvent, for example by coagulation into a bath comprising a non-solvent such as water and/or a C1-C5 alcohol, preferably methanol, or by devolatilization of the solvent.

The PAES polymer described herein may be characterized by its weight average molecular weight (Mw). The PAES described herein is advantageously characterized in that its weight average molecular weight (Mw) ranges between 30,000 g/mol and 150,000 g/mol, or between 40,000 g/mol and 130,000 g/mol, or between 45,000 g/mol and 120,000 g/mol or between 70,000 g/mol and 110,000 g/mol, or between 70,000 g/mol and 110,000 g/mol. The weight average molecular weight (Mw) of the PAES is determined by Gel Permeation Chromatography (GPC) using Methylene Chloride as a mobile phase, using polystyrene standards for calibration.

### Method for Making the Shaping Article

The method for making the shaped article according to the present invention may comprise melt processing a polymer composition comprising the naphthalene diol-based PAES described herein to form the article. In some embodiments, the melt processing includes heating the polymer composition. In preferred embodiments, the melt processing is carried out such that the polymer composition is at a temperature from 300° C. to 420° C.

Suitable melt processing may include extrusion molding, injection molding, blow molding, pultrusion, thermoforming, rotomolding, overmolding, melt and/or powder coating, and/or compression molding of the polymer composition comprising the PAES polymer described herein, injection molding being a preferred shaping method, when aiming at making the shaped article.

The polymer composition comprising the PAES polymer may further include one or more optional additional ingredients, such as one or more polymers distinct from the naphthalene diol-based PAES described herein, a solvent, a filler, a lubricant, a light stabilizer, a UV stabilizer, a heat stabilizer, a plasticizer, an impact modifier/toughener, a nucleating agent, an antioxidant, a mold release, an antistatic agent, a flame retardant, an anti-fogging agent, a matting agent, a pigment, a dye and/or an optical brightener.

A large selection of fillers may be added optionally to the polymer composition. They can be selected from fibrous and particulate fillers. A fibrous filler is considered herein to be a tri-dimensional material having length, width and thickness, wherein the average length is significantly larger than both the width and thickness. The optional filler may be selected from mineral fillers (such as talc, mica, kaolin, calcium carbonate, calcium silicate, magnesium carbonate), carbon fibers, synthetic polymeric fibers, aramid fibers, aluminum fibers, titanium fibers, magnesium fibers, boron carbide fibers, rock wool fibers, steel fibers, wollastonite, glass balls (e.g., hollow glass microspheres), and/or glass fibers.

The polymer composition comprising the PAES polymer may comprise more than 0 wt % and up to 20 wt % (based on the total weight of the polymer composition) of one or more optional additional ingredients excluding fillers.

The polymer composition comprising the PAES polymer may comprise more than 5 wt % and up to 70 wt % (based on the total weight of the polymer composition) of one or more optional additional fillers.

The polymer composition comprising the PAES polymer is preferably provided by melt-blending the naphthalene diol-based PAES and one or more optional additional ingredients described herein prior to or during the melt processing step. In some instances, the naphthalene diol-based PAES and other optional ingredient(s) may be fed into a melt mixer, such as single screw extruder or twin screw extruder, agitator, single screw or twin screw kneader, or Banbury mixer, together or added separately.

If the polymer composition comprising the PAES polymer further contains a fibrous filler which presents an elongated physical shape (for example, a ‘continuous’ fiber having a length greater than or equal to about 50 mm, different than chopped or milled fibers with a shorter length), drawing extrusion molding, pultrusion to form long-fiber pellets or pultrusion to form unidirectional composite tapes may be used to prepare a reinforced shaped article. As opposed to extrusion, which pushes the polymer composition through a die, pultrusion pulls the polymer composition through the die. Pultrusion is particularly useful for making composites.

The shaped article comprising the polymer (PAES) can undergo post-fabrication operations such as ultrasonic welding, adhesive bonding, and laser marking as well as heat staking, threading, and machining.

### Use of the Shaped Article

Another aspect of the present disclosure is directed to the use of the shaped article in food, beverage, medical, automotive, aerospace, electrical, electronic, and industrial product applications and/or in composites.

As non-limiting examples, the shaped article may be used in biomedical applications such as biomedical tubing, in food and beverage applications such as baby bottles or other food containers, in coatings and/or in tough thermoplastic composites.

Should the disclosure of any patents, patent applications, and publications which are incorporated herein by reference conflict with the description of the present application to the extent that it may render a term unclear, the present description shall take precedence

Exemplary embodiments will now be described in the following non-limiting examples.

### EXAMPLES

### Raw Materials

4,4′-dichlorodiphenyl sulfone (DCDPS), available from Solvay Speciality Polymers
1,5 Naphthalene diol (1,5-NDO) available from Sigma-Aldrich
2,7 Napthalene diol (2,7-NDO) available from Sigma-Aldrich
2,3 Napthalene diol (2,3-NDO) available from Sigma-Aldrich
K₂CO₃ (Potassium Carbonate), available from Armand products
Sulfolane, available from Chevron Phillips
Chlorobenzene available from Sigma-Aldrich
DMSO available from Sigma-Aldrich
NaOH, available from Sigma-Aldrich
PSU Udel® P3500, available from Solvay Speciality Polymers
PPSU Radel® R5100 available from Solvay Speciality Polymers
PES Veradel® 300MP, available from Solvay Speciality Polymers
Polyetherimide (PEI) Ultem® 1010, available from SABIC

### Test Methods

### GPC—Molecular Weight (Mn, Mw)

The molecular weights (Mn, Mw) of the napthalenediol-based polysulfones were measured by gel permeation chromatography (GPC), using methylene chloride as a mobile phase. Two 5p mixed D columns with guard column from Agilent Technologies were used for separation. An ultraviolet detector of 254 nm was used to obtain the chromatogram. A flow rate of 1.5 ml/min and injection volume of 20 μL of a 0.2 w/v % solution in mobile phase was selected. Calibration was performed with 12 narrow molecular weight polystyrene standards (Peak molecular weight range: 371,000 to 580 g/mol). The molecular weight average values (Mn, Mw) defined as follows:

$${M}_{n} = \frac{{\sum }_{i} {W}_{i}}{{\sum }_{i} {W}_{i} / {M}_{i}} ; {M}_{w} = \frac{{\sum }_{i} {W}_{i} {M}_{i}}{{\sum }_{i} {M}_{i}}$$

where Wi is the weight of molecules having molecular weight Mi, were reported.

### PDI

The napthalenediol-based sulfone polymers were also characterized by their respective polydispersity index (“PDI” or “PDI index” herewith), also called sometimes polymolecularity index. The polydispersity or polymolecularity corresponds to the molecular weight distribution of the various macromolecules within the polymer. The PDI was calculated from the ratio Mw/Mn, the number average molecular weight Mn and weight average molecular weight Mw being determined as detailed above.

### Thermal Gravimetric Analysis (TGA)

TGA experiments were carried out using a TA Instrument TGA Q500. TGA measurements were obtained by heating the sample at a heating rate of 10° C./min from 20° C. to 800° C. under nitrogen.

### ¹H NMR

¹H NMR spectra were measured using a 400 MHz Bruker spectrometer with TCE or DMSO as the deuterated solvent. All spectra are reference to residual proton in the solvent.

### Differential Scanning Calorimeter (DSC)

DSC was used to determine glass transition temperatures (Tg) and melting points (Tm)-if present. DSC experiments were carried out using a TA Instrument Q100. DSC curves were recorded by heating, cooling, re-heating, and then re-cooling the sample between 25° C. and 320° C. at a heating and cooling rate of 20° C./min. All DSC measurements were taken under a nitrogen purge. The reported Tg values were provided using the second heat curve unless otherwise noted.

### Elastic Modulus

The modulus of elasticity ‘E’ (or tensile modulus) was measured via ASTM D5279—Dynamic Mechanical Properties in Torsion at two different temperatures: 50° C. (‘E₅₀’) and 190° C. (‘E₁₉₀’) using a TA Instruments ARES-G2 rotational rheometer. A temperature ramp from 10-200° C. @5° C./min was used with a frequency of 10 Hz and a strain of 0.05%. Sample specimens in the form 500-micron thick sheets were fabricated using compression molding process.

### VR40

The melt stability was measured using a Dynisco LCR 7000 Capillary Rheometer using ASTM D3835. A measurement temperature of 380 or 410° C. and a melt time of 300 seconds was used. The shear rate was 46.4 1/s and die ratio of L/D:20 was used. The melt stability, VR40, was calculated by the ratio of the viscosity measured at 40 minutes (2400 sec) over the viscosity at 10 minutes (600 sec) measured at a given temperature.

### Example 1: Synthesis of the 2,7-Napthalene Diol Based Polysulfone (P1) Using Weak Alkali Reaction Conditions (K₂CO₃) and DCDPS

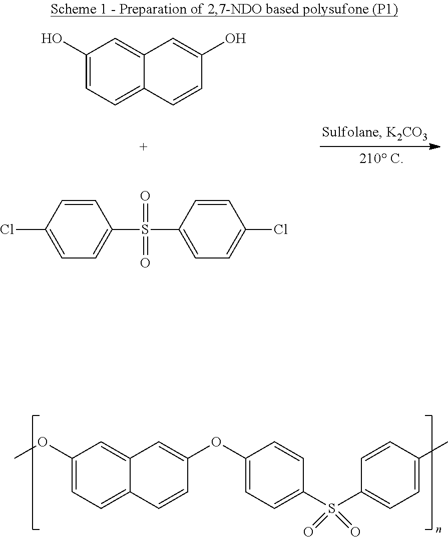

The 2,7-NDO based polysulfone (P1) was prepared according to Scheme 1.

The polymerization took place in a (1-L) glass reactor vessel fitted with an overhead stirrer, nitrogen inlet and an overhead distillation set-up. The monomers: 4,4′-dichlorodiphenyl sulfone (200.49 g) and 2,7-napthalenediol (112.12 g) were added to the vessel first, followed by the addition of potassium carbonate (105.43 g), and sulfolane (611.6 g). The reaction mixture was heated from room temperature to 210° C. using a 150° C./min heating ramp. The temperature of the reaction mixture was maintained for 45 minutes to one hour, depending upon the viscosity of the solution. The reaction was terminated by methyl chloride and sulfolane addition, stopping the heat. The reaction mixture was filtered, coagulated into methanol and dried at 110° C.

### Characterization of the 2,7-NDO Based Sulfone Polymer (P1)

TABLE 1

| | |
|---|---|
| M_{w} (g/mol) | 82000 |
| Mₙ (g/mol) | 26981 |
| M_{w}/Mₙ = PDI | 3.04 |
| DSC-second heat - Tg (° C.) | 209 |
| TGA- Onset T_{deg.} (° C.) | 542 |

### Example 2: Synthesis of 2,7-Napthalene Diol Based Sulfone Polymer (P2) Using Strong Alkali Reaction Conditions (NaOH) and DCDPS

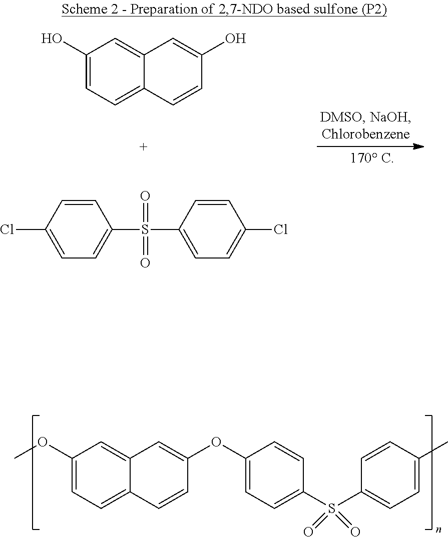

The 2,7-NDO based sulfone polymer (P2) was prepared according to Scheme 2.

The polymerization took place in a (1-L) glass reactor vessel fitted with an overhead stirrer, nitrogen inlet and vigreux column, a modified barrette trap with water-cooled condenser. The 2,7-napthalenediol (93.62 g), DMSO (54.4 g) and monochlorobenzene (319 g) were added to the vessel first, then stoichiometric amount of NaOH in the form of 50% aqueous solution was slowly added to the mixture and purged with nitrogen gas for half an hour at room temperature. The reaction was azeotropically dehydrated using monochlorobenzene until the internal reaction temperature reached about 150° C. after which DCDPS (169.43 g) was then introduced as a hot solution in monochlorobenzene (129 g) at a temperature of around 120° C. The reaction temperature was increased to 170° C. and the reaction was continued until a high molecular weight polymer in formed. The reaction mixture was quenched with monochlorobenzene (400 g) and cooled to 120° C.

Termination of the reaction was carried out by introducing methyl chloride gas slowly for 20 minutes (^{˜}20-22 g). After methyl chloride addition, 2.7 g of aqueous caustic (25 wt % NaOH) was added and the mixture was stirred for 15 minutes followed by addition of methyl chloride (15-20 g). The reaction mixture was cooled to 90° C. by adding 200 g monochlorobenzene. A dilute oxalic acid DMSO solution (1.7 g in 193 g of DMSO) was added to the reaction mixture until a pH of 4 was obtained (as measured by a pH paper). The reaction mixture was filtered, coagulated into methanol, washed with methanol twice and dried at 110° C.

### Characterization of the 2,7-NDO Based Sulfone Polymer (P2)

TABLE 2

| | |
|---|---|
| Mw (g/mol) | 48239 |
| Mn (g/mol) | 18542 |
| Mw/Mn = PDI | 2.6 |

### Example 3: Synthesis of 1,5-Napthalene Diol Sulfone Polymer (P3) Using Weak Alkali Reaction Conditions (K₂CO₃) and DCDPS

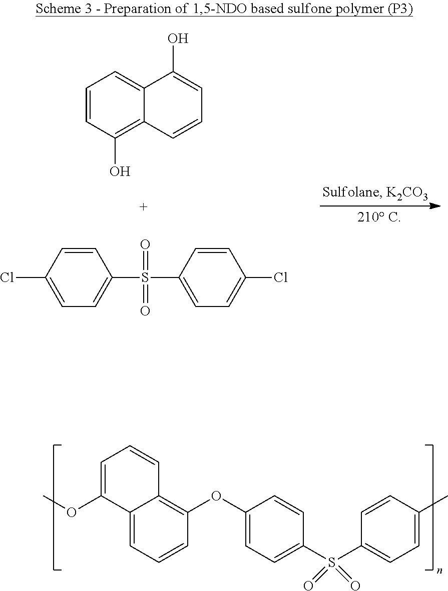

The 1,5-NDO based sulfone polymer (P3) was prepared according to Scheme 3.

The polymerization took place in a glass reactor vessel (1-L) fitted with an overhead stirrer, nitrogen inlet and an overhead distillation set-up. The monomers 4,4′-dichlorodiphenyl sulfone (200.99 g), 1,5 dihydroxynapthalene (112.11 g) were added to the vessel first, followed by the addition of potassium carbonate (145.15 g), and sulfolane (395.35 g).The reaction mixture was heated from room temperature to 210° C. using a 150° C./mi heating ramp. The temperature of the reaction mixture was maintained for 45 minutes to one hour, depending upon the viscosity of the solution. The reaction was terminated by methyl chloride and sulfolane addition, stopping the heat. The reaction mixture was filtered, coagulated into methanol and dried at 110° C.

### Characterization of the 1,5-NDO Based Sulfone Polymer (P3)

TABLE 3

| | |
|---|---|
| Mw (g/mol) | 102983 |
| Mn (g/mol) | 22172 |
| Mw/Mn = PDI | 4.64 |

### Example 4: Synthesis of 2, 3-Napthalenediol Based Polysulfone (P4) Using Weak Alkali Reaction Conditions (K₂CO₃) and DCDPS

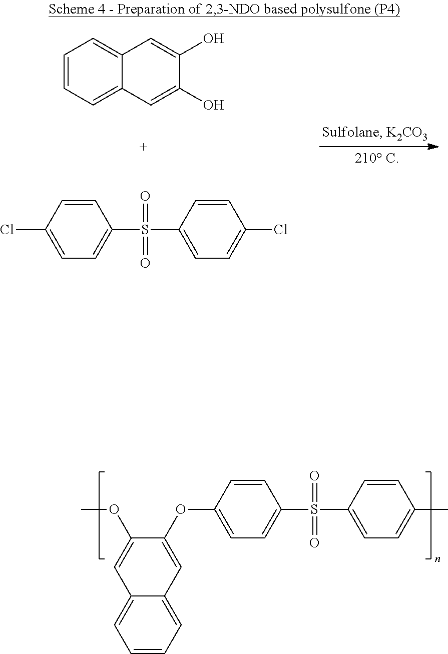

The 2, 3-NDO based polysulfone (P4) was prepared according to Scheme 4.

The polymerization took place in a 1-L glass reactor vessel fitted with an overhead stirrer, nitrogen inlet and an overhead distillation set-up. The DCDPS (201.04 g) and 2,3-napthalene diol (112.1 g) were added to the vessel first, followed by the addition of potassium carbonate (145.1 g), and sulfolane (393 g).The reaction mixture was heated from room temperature to 210° C. using a 150° C./min heating ramp. The temperature of the reaction mixture was maintained for 45 minutes to one hour, depending upon the viscosity of the solution. The reaction was terminated by methyl chloride and sulfolane addition, stopping the heat. The reaction mixture was filtered, coagulated into methanol and dried at 110° C.

### Characterization of the 2,3-NDO Based Sulfone Polymer (P4)

TABLE 4

| | |
|---|---|
| Mw (g/mol) | 83310 |
| Mn (g/mol) | 7083 |
| Mw/Mn = PDI | 11.7 |
| (Tg ° C.) DSC | 202.4 |

### Example 5: Melt Stability Evaluation

VR40 measurements were carried out at 380° C. and 410° C. for the 2,7-NDO based sulfone polymer (P1) made in Example 1 and reported in Table 5.

At VR40 of about 1 at 380° C., there was no measureable change in the melt viscosity of the polymer (P1) over 35 minutes (40 minutes-5 minutes). Accordingly, the polymer P1 having a VR40 closer to 1 has increased melt viscosity stability, relative to other polymers having a VR40 farther away from 1.

A VR40 value measured at 410° C. was 1.9.

The result indicates that this material can be thermally processed.

TABLE 5

| | |
|---|---|
| VR40 (410° C.) | 1.9 |
| VR40 (380° C.) | 0.98 |

### Example 6: Elastic Modulus and Tg

Elastic modulus measurements were carried out at 50° C. and 190° C. for 2,7-NDO based sulfone polymer (P1) made in Example 1 and also for 1,5-NDO based sulfone polymer (P3) made in Example 3.

For comparison, the elastic modulus at 50° C. and 190° C. of commercially-available amorphous sulfone polymers: PSU Udel® P3500, PPSU Radel® R5100, and PES Veradel® 300MP sold by Solvay Specialty Polymers, as well as of commercially-available amorphous polyetherimide polymer Ultem® 1010 sold by Sabic.

The elastic modulus measurements at 50° C. (E₅₀) and 190° C. (E₁₉₀) as well as the percentage loss in elastic modulus (“% loss”)=(E₅₀−E₁₉₀)/E₅₀) and Tg (measured by DSC) are reported in Table 6.

TABLE 6

| | Elastic Modulus (MPa) | | | |
|---|---|---|---|---|
| | ASTM D5279 | | | Tg (° C.) |
| | E₅₀ | E₁₉₀ | % loss | DSC |
| Udel ® P3500 PSU | 843 | 244 | 71 | 191 |
| Radel ® R5100 PPSU | 473 | 388 | 18 | 225 |
| Veradel ® 300MP PES | 1070 | 969 | 9 | 232 |
| 1,5-NDO based (P3) | 622 | 421 | 32 | 237 |
| 2,7-NDO based (P1) | 940 | 833 | 11 | 209 |
| Ultem ® PEI 1010 | 1041 | 782 | 25 | 219 |

The results in Table 6 shows that the 2,7-NDO based polymer (P1) outperformed Udel® PSU, Radel® PPSU and the 1,5-NDO based polymer (P3) in terms of thermo-mechanical properties. The 2,7-NDO based polymer (P1) had very similar thermo-mechanical properties as compared to Veradel® PES. The 2,7-NDO based polymer (P1) had a loss of 11% in the elastic modulus when the temperature was increased from 50 to 190° C. while Veradel® PES had a loss of 9%. The other tested polymers had a loss from 18% to 71%. Because the 2,7-NDO based polymer (P1) was prepared from a diol monomer which had a much lower estrogenic activity compared to Veradel® PES made from Bisphenol S (BPS)—see results in Example 7, articles comprising or made from the 2,7-NDO based polymer (P1) would then have an advantage over Veradel® PES in applications where endocrine activity or toxicity may be a concern.

### Example 7: Determination of the EC₅₀ (nM) Response Value to the Estrogen Receptor Alpha (ER□)

The response value “EC₅₀” was measured by using the GeneBLAzer® Cell-Based Nuclear Receptor Assay technology which uses the GeneBLAzer®. Betalactamase reporter technology with, which is notably described in U.S. Pat. No. 5,955,604 and also in US2014/113093A1 incorporated herein by reference in their entirety.

The monomers (see Table 7) were dissolved in 100% biological-grade DMSO at a concentration of 7 to 250000 nM (nanomolar). The ER-α-UAS-bla GripTite™ 293 cells were used to measure EC₅₀. The higher the EC₅₀ value is, the weaker the estrogenic agonist activity is for the monomer tested.

The GeneBLAzer® ER-α-UAS-bla GripTite™ cells contain a ligand-binding domain (LBD) of the human Estrogen receptor alpha (ERα) fused to a DNA-binding domain of GAL4 plasmid stably integrated in the GeneBLAzer® UAS-bla GripTite™ cell line. The GeneBLAzer® UAS-bla GripTite™ cells stably express a beta-lactamase reporter gene under the transcriptional control of an upstream activator sequence (UAS). When an estrogenic agonist binds to the LBD of the GAL4 (DBD)-ER α (LBD) fusion protein, the protein binds to the UAS, resulting in expression of beta-lactamase.

The results in Table 7 indicates that the 3 naphthalene diol isomers tested (1,5-NDO, 2,3-NDO, 2,7-NDO) had a much lower estrogenic activity on ERα cells than BPA, BPS and BP. Their respective EC₅₀ value were at least 30000 nM, that is to say, at least 10-fold higher than BP and at least 100-fold higher than BPA.

TABLE 7

| Diol monomer | EC₅₀ (nM) |
|---|---|
| BPA | 263 |
| BPS | 791 |
| BP | 2920 |
| 1,5-NDO | >79100 |
| 2,7-NDO | 32000 |
| 2,3-NDO | >79100 |

1. A shaped article, comprising at least one poly(aryl ether sulfone) (PAES) polymer, said PAES comprising at least 80 mol. %, based on the total number of moles of recurring units in the PAES polymer, of recurring units (R_{PAES}) of formula (I): 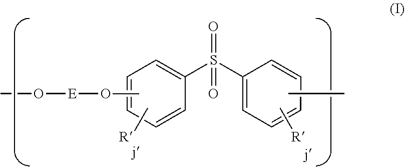
wherein:
E is selected from formula (IIa) 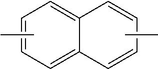
and/or formula (IIb) 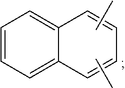
each R′ is, independently at each location, an alkyl having from 1 to 5 carbon atoms; and
j′ is 0 or an integer from 1 to 10.

2. The shaped article of claim 1, wherein the PAES polymer comprises at least 90 mol. % of the recurring units (R_{PAES}) of the formula (I), said mol. % being based on the total number of moles of recurring units in the PAES polymer.

3. The shaped article of claim 1, being substantially free of 4,4′-dihydroxydiphenyl sulfone (BPS), 4,4′-isopropylidenediphenol (BPA), and/or 4,4′-biphenol (BP).

4. The shaped article of claim 1, wherein E in the recurring units (R_{PAES}) is selected from the group consisting of: 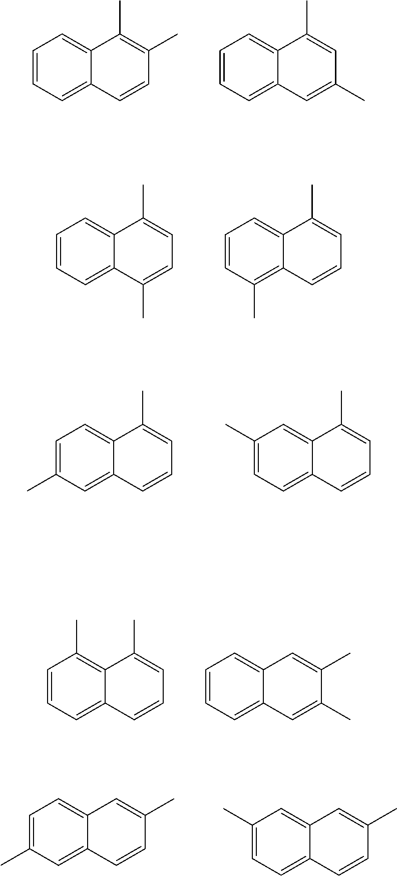
and any combinations thereof.

5. The shaped article of claim 1, wherein the recurring units (R_{PAES}) are selected from the group consisting of formulae (I-a), (I-b), (I-c) and any combinations thereof:

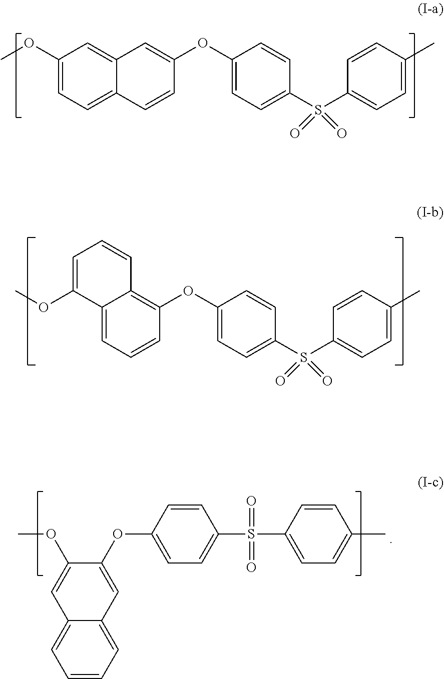

6. The shaped article of claim 6, wherein the recurring units (R_{PAES}) are of formula selected from formulae (I-a) and/or (II-b).

7. The shaped article of claim 1, obtained by the condensation in a reaction mixture (R_{G}) of:
at least one aromatic dihydroxy monomer (a), comprising at least 80 mol %, based on the total number of moles of monomer (a), of at least one naphthalene diol monomer (a1) of formula (IIIa) and/or (IIIb): 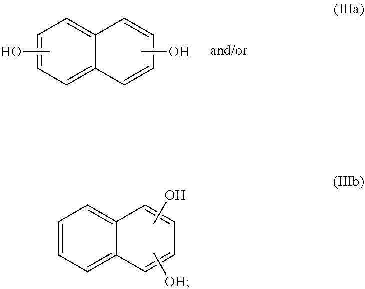
at least one aromatic dihalogen sulfone monomer (b), comprising at least 80 mol %, based on the total number of moles of monomer (b), a monomer (b1) of formula (IV): 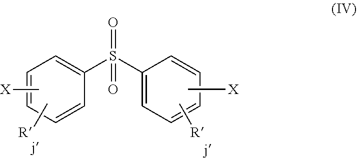
at least one carbonate component,
in a solvent,
wherein:
each R′ is, independently at each location, an alkyl having from 1 to 5 carbon atoms;
j′ is an integer from 0 to 10; and
X is an halogen atom.

8. The shaped article of claim 7, wherein the naphthalene diol monomer (a1) has an EC₅₀ response value to the estrogen receptor alpha (ERα) of at least 30000 nM.

9. The shaped article of claim 7, wherein the monomer (b) comprises at least 50 mol. % of 4,4′-dichlorodiphenyl sulfone (DCPDS) and/or 4,4′-difluorodiphenyl sulfone (DFPDS) as monomer (b1), based on the total number of moles of aromatic dihalogen sulfone monomer (b).

10. The shaped article of claim 7, wherein the monomer (a) excludes at least one of 4,4′-dihydroxydiphenyl sulfone (BPS), 4,4′-isopropylidenediphenol (BPA), and/or 4,4′-biphenol (BP).

11. The shaped article of claim 1, wherein the PAES polymer has at least one of the following properties:
a high temperature elastic modulus E₁₉₀≥400 MPa, measured at 190° C. via ASTM D5279; and/or
a suitable melt stability represented by VR40 from 0.95 to 1.05 measured at 380° C., wherein VR40 is the ratio MV40/MV5 of the melt viscosity at 40 minutes (“MV40”) to melt viscosity at 5 minutes (“MV5”), said melt viscosities being measured at 380° C. using ASTM D3835; and/or
a glass transition temperature Tg of from 200° C. to 250° C., wherein the Tg is measured via Differential Scanning Calorimeter (DSC).

12. The shaped article of claim 1, wherein the PAES polymer has a low thermal loss in elastic modulus (% loss) of at most 15%,
wherein % loss=(E₅₀−E₁₉₀)/E₅₀, said E₅₀ being the elastic modulus of the PAES polymer measured at 50° C., and E₁₉₀ being the elastic modulus of the PAES polymer measured at 190° C., both measured using ASTM D5279.

13. The shaped article of claim 1, being selected from the group consisting of a tubing, a food or beverage container, a pipe, a fitting, a housing, a coating, a composite or any component thereof.

14. A method for making the shaped article according to claim 1, comprising melt processing a polymer composition comprising the PAES polymer to form the shaped article, wherein the melt processing includes heating the polymer composition.

15. The method according to claim 14, wherein the melt processing includes extrusion molding, injection molding, blow molding, pultrusion, thermoforming, rotomolding, overmolding, melt and/or powder coating, and/or compression molding of the polymer composition.

16. The method according to claim 14, wherein the polymer composition further includes at least one additional ingredient selected from the group consisting of: one or more polymers distinct from the PAES polymer, a solvent, a filler, a lubricant, a light stabilizer, a UV stabilizer, a heat stabilizer, a plasticizer, an impact modifier/toughener, a nucleating agent, an antioxidant, a mold release, an antistatic agent, a flame retardant, an anti-fogging agent, a matting agent, a pigment, a dye and an optical brightener.

17. (canceled)
